(19) United States
(12) Patent Application Publication
(10) Pub. No.: US 2004/0035262 A1
(43) Pub. Date: Feb. 26, 2004

(54) Reinforcement for movable jaw of an adjustable wrench

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,511

(22) Filed: Aug. 21, 2002

(51) Int. Cl. B25B 13/16

(52) U.S. Cl. 81/170

(57) ABSTRACT

An adjustable wrench includes a handle and a fix jaw extends from an end of the handle. A movable jaw has an end movably received in a groove and engaged with an adjustment screw which rotates to move the movable jaw. Two rails extend from the end of the handle and are located such that the groove is located between the two protrusions. The movable jaw is moved along the two rails.

### FIELD OF THE INVENTION

The present invention relates to an adjustable wrench having a fixed jaw and a movable jaw, wherein the movable jaw is movably on two rails extending from an end of the handle so as to bear a large torque.

### BACKGROUND OF THE INVENTION

A conventional adjustable wrench generally includes a handle with a fixed jaw extending from an end of the handle and a movable jaw is movably engaged with a groove so that the gap between the fixed jaw and the movable jaw can be adjusted. An adjustment screw is rotatably engaged with an underside of the movable jaw which is movably engaged in the groove so that when rotating the adjustment screw, the movable jaw is moved relative to the fixed jaw. An object is clamped between the fixed jaw and the movable jaw and the handle is rotated to exert a torque to the object so as to tighten or loosen the object. During rotating, the fixed jaw and the movable jaw both are suffered by the torque, and the movable jaw could be damaged at the position where the adjustment screw is connected to.

The present invention intends to provide an adjustable wrench wherein the movable jaw is movably engaged with two rails and so that the connection portion between the movable jaw and the adjustment screw is suffered by less stress concentration.

### SUMMARY OF THE INVENTION

In accordance with one aspect of the present invention, there is provided an adjustable wrench which comprises a handle and a fix jaw extends from an end of the handle. A groove is defined in the end and an adjustment screw is rotatably received in the end of the handle. A movable jaw has an end movably received in the groove and engaged with the adjustment screw. Two rails extend from the end of the handle and the movable jaw is movably along the two rails.

The primary object of the present invention is to provide a adjustable wrench wherein the movable jaw are moved along two rails so as to have better support to bear a large torque.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the adjustable wrench of the present invention;

FIG. 2 shows two side views of the adjustable wrench of the present invention; and

FIG. 3 shows another embodiment of the adjustable wrench of the present invention.

### DETAILED DESCRIPTION OF THE PREFERRED EMBODIMENT

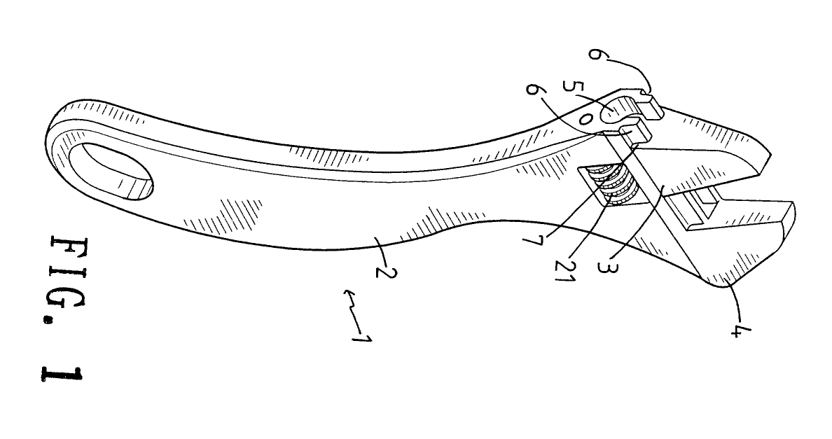

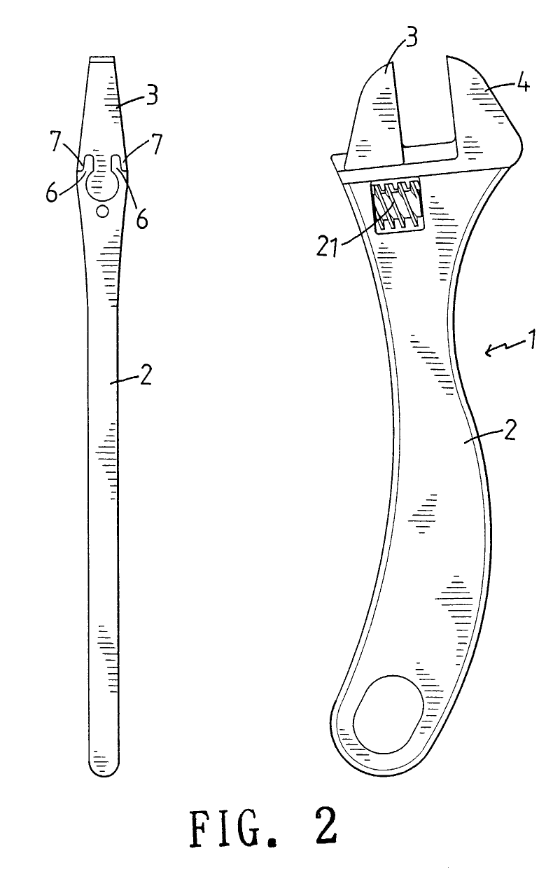

Referring to FIGS. 1 and 2, the adjustable wrench 1 of the present invention comprises a handle 2 and a fix jaw 4 extends from an end of the handle 2. A groove 5 is defined in the end and an adjustment screw 21 is rotatably received in the end of the handle 2. A movable jaw 3 has an end movably received in the groove 5 and engaged with the adjustment screw 21 so that when rotating the adjustment screw 21, the movable jaw 3 is moved in the groove 5.

Two rails 6 extend from the end of the handle 2 and are located such that the groove 5 is located between the two protrusions 6. The movable jaw 3 has two notches 7 which receive the two protr4usions 6 therein so that the movable jaw 3 is moved along the two rails 6.

When the movable jaw 3 is exerted a torque, the two rails 6 dispense part of the torque so that the connection portion of the movable jaw 3 and the adjustment screw 21 bears less torque and stress concentration. By these rails 6, the movable jaw 3 has stronger back-up so bear large torque.

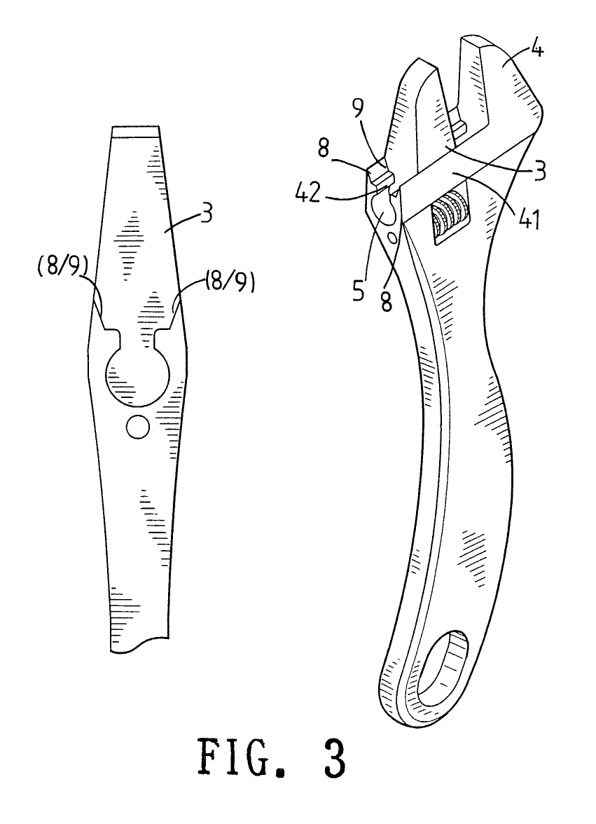

FIG. 3 shows another embodiment of the adjustment wrench wherein two extensions 41 extend from two sides of the fixed jaw 4 and the movable jaw 3 is located between the two extensions 41. Each inside of the two extensions 41 includes an inclined surface 8 and the movable jaw 3 has two inclined matching surfaces 9 which are movably on the two inclined surfaces 8 of the two extensions 41. Two rails 42 extend from two respective inclined surfaces at the insides of the two extensions 41 and the movable jaw 3 has two notches for receiving the two rails 42. The movable jaw 3 is supported on two sides thereof and will not shank after being used for a period of time.

While we have shown and described the embodiment in accordance with the present invention, it should be clear to those skilled in the art that further embodiments may be made without departing from the scope of the present invention.

What is claimed is:

1. An adjustable wrench comprising:
a handle and a fix jaw extending from an end of the handle, a groove defined in the end and an adjustment screw rotatably received in the end of the handle, a movable jaw having an end movably received in the groove and engaged with the adjustment screw, and
two rails extending from the end of the handle and being located such that the groove is located between the two protrusions, the movable jaw moved along the two rails.

2. A adjustable wrench comprising:
a handle and a fix jaw extending from an end of the handle, a groove defined in the end and an adjustment screw rotatably received in the end of the handle, a movable jaw having an end movably received in the groove and engaged with the adjustment screw, and
two extensions extending from two sides of the fixed jaw and the movable jaw located between the two extensions, two rails extending from two respective insides of the two extensions and the movable jaw having two notches for receiving the two rails.

3. The wrench as claimed in claim 2, wherein each inside of the two extensions includes an inclined surface and the movable jaw has two inclined matching surfaces which are movably on the two inclined surfaces of the two extensions.
